(19) United States
(12) Patent Application Publication
(10) Pub. No.: US 2015/0349948 A1
(43) Pub. Date: Dec. 3, 2015

(54) SIDE CHANNEL ANALYSIS SYSTEM AND SIDE CHANNEL ANALYSIS METHOD USING THE SAME

(71) Applicant: Electronics and Telecommunications Research Institute, Daejeon (KR)

(72) Inventors: Ju Han KIM, Daejeon (KR); Doo Ho CHOI, Cheonan-si (KR); Yong Je CHOI, Daejeon (KR)

(21) Appl. No.: 14/682,632

(22) Filed: Apr. 9, 2015

(30) Foreign Application Priority Data
May 27, 2014 (KR) 10-2014-0063687

(51) Int. Cl. H04L 9/00

(52) U.S. Cl. CPC H04L 9/003

(57) ABSTRACT

Disclosed are a side channel analysis system that may facilitate to perform side channel analysis on a device whose dedicated side channel analysis board does not exist such as a smartphone, and a side channel analysis method using the same. The side channel analysis system includes a side channel analysis device that outputs control signals for side channel analysis and performs side channel analysis based on received measurement signals, a device to be analyzed that performs generation and encryption function of optical signals for side channel measurement, according to the control signals provided from the side channel analysis device, an optical sensor module that detects the optical signals generated from the device to be analyzed, and generates and outputs trigger signals according to the detected optical signals, and a signal measurement device that measures waveforms of at least one signal generated according to an encryption operation of the device to be analyzed using the trigger signals output from the optical sensor module, and provides the measured waveforms to the side channel analysis device.

### CROSS-REFERENCE TO RELATED APPLICATION

This application claims priority to and the benefit of Korean Patent Application No. 10-2014-0063687, filed on May 27, 2014, the disclosure of which is incorporated herein by reference in its entirety.

### BACKGROUND

1. Field of the Invention

The present invention relates to side channel analysis technology, and more particularly, to a side channel analysis system that may facilitate to perform side channel analysis on a device whose dedicated side channel analysis board does not exist such as a smartphone, and a side channel analysis method using the same.

2. Discussion of Related Art

An encryption analysis method that may find out confidential information such as private keys by measuring power consumption generated in an operation process of an encryption algorithm or measuring an operation execution time has been developed.

The leakage of confidential information about the encryption algorithm is referred to as a side channel, and an attack method using the side channel is referred to side channel attack.

Such side channel attack is roughly classified into timing attack, fault insertion attack, power analysis attack, and the like.

As to such side channel attack, side channel attack technology as one of powerful attack techniques against the encryption algorithm gradually becomes a major threat to security products.

Side channel analysis uses a lot of power consumption waveforms generated while encryption hardware or software is driven, but in order to collect such power consumption waveforms, a waveform collection device is necessarily needed.

As a side channel analysis method that is currently used, a method that may collect, pre-process, and analyze waveforms such as electric power, electromagnetic waves, and the like generated when an encryption module of a device to be analyzed is driven, using the waveform collection device such as an oscilloscope, and therefore find out a key of the encryption module driven in the corresponding device may be used.

Current side channel analysis systems perform side channel analysis using a method of precisely collecting waveforms by operating a trigger of the oscilloscope when a security module of the device to be analyzed is executed. That is, when using the oscilloscope, the trigger may be operated in a desired position, and therefore it is possible to easily collect a desired waveform and a desired number of waveforms.

However, except for the existing software (S/W) side channel analysis board, hardware (H/W) side channel analysis board, smart card side channel analysis board, and the like on which side channel analysis is to be performed, there is no method to transmit the waveforms to the oscilloscope in the system.

FIG. 1 is a configuration diagram illustrating a general side channel analysis system 100.

Referring to FIG. 1, conventionally, side channel analysis has been performed in such a manner that a side channel analysis board 120 controlled by a side channel analysis device 110 provides a trigger to an oscilloscope 130, the oscilloscope 130 measures and collects waveforms from a device to be analyzed according to the provided trigger to transmit the measured and collected waveforms to the side channel analysis device 110, and then the side channel analysis device 110 analyzes the transmitted waveforms.

Thus, in order to perform side channel analysis using the side channel analysis system, the waveforms should be collected by precisely inputting the trigger when the encryption module is operated.

In particular, in a smartphone or the like, the operation of the encryption module is completed within approximately 1 ms, and therefore trigger input having a delaying property equivalent to this should be performed, but an analysis board for the smartphone hasn't been developed yet.

In addition, one of the reasons why the conventional side channel analysis system cannot be applied to the smartphone is because, in the smartphone, there is no terminal that can provide the trigger to the oscilloscope.

Thus, in order to provide the trigger to the oscilloscope, a side channel analysis board for the smartphone should be manufactured, but a lot of difficulties may be expected in manufacturing a general-purpose side channel analysis board due to many kinds of OSs and terminals of the smartphone.

### SUMMARY OF THE INVENTION

The present invention is directed to a side channel analysis system that may facilitate to perform side channel analysis on a device whose dedicated side channel analysis board does not exist such as a smartphone, and a side channel analysis method using the same.

According to an aspect of the present invention, there is provided a side channel analysis system including: a side channel analysis device that outputs control signals for side channel analysis and performs side channel analysis based on received measurement signals; a device to be analyzed that performs generation and encryption function of optical signals for side channel measurement, according to the control signals provided from the side channel analysis device; an optical sensor module that detects the optical signals generated from the device to be analyzed, and generates and outputs trigger signals according to the detected optical signals; and a signal measurement device that measures waveforms of at least one signal generated according to an encryption operation of the device to be analyzed using the trigger signals output from the optical sensor module, and provides the measured waveforms to the side channel analysis device.

Here, the device to be analyzed may include an encryption module that performs the encryption function according to the control signals provided from the side channel analysis device, and a flash device that controls generation of the optical signals by turning on/off a flash function according to the control signals provided from the side channel analysis device.

Also, the encryption module may perform the encryption function after outputting light by turning on the flash function of the flash device, or perform the encryption function in a state of turning off the flash function.

Also, the side channel analysis device and the device to be analyzed may be connected with each other via at least one of a USB and a Wi-Fi interface.

According to another aspect of the present invention, there is provided a side channel analysis system including: a signal measurement device that measures signals for side channel analysis of a device on which side channel analysis is to be performed; and a side channel analysis device that performs side channel analysis using the signals measured by the signal measurement device. Here, the device on which side channel analysis is to be performed may include an encryption module that performs an encryption function according to analysis control data provided from the side channel analysis device, an optical generation module that generates optical signals according to the analysis control data provided from the side channel analysis device, and an optical sensor module that detects the optical signals generated from the optical generation module, and provides the detected optical signals as trigger signals for signal measurement in the signal measurement device.

According to still another aspect of the present invention, there is provided a side channel analysis method including: performing, by a device to be analyzed, an encryption function and a flash function according to side channel analysis control signals provided from a side channel analysis device; detecting, by an optical sensor module, optical signals generated according to the flash function from the device to be analyzed, and outputting the detected optical signals as trigger signals; measuring, by the device to be analyzed, signals generated while performing the encryption function according to the trigger signals output from the optical sensor module, and providing the measured signals from a signal measurement device to the side channel analysis device; and performing, by the side channel analysis device, side channel analysis by receiving the measured signals provided from the signal measurement device.

Here, the side channel analysis method may further include setting, by the side channel analysis device, an operation parameter for performing generation and encryption function of optical signals in the device to be analyzed, and providing side channel analysis control signals according to the set operation parameter to the device to be analyzed via a communication interface.

Also, a communication interface for transmitting side channel analysis control signals to the device to be analyzed may use at least one of a USB and a Wi-Fi interface.

Also, the performing of the encryption function and the flash function may include performing, by an encryption module, an encryption operation in a state in which a flash device is turned on so that light is output, or performing, by the encryption module, the encryption operation in a state in which the flash device is turned off so that light is not output.

Also, the performing, by the side channel analysis device, side channel analysis may include collecting measured waveforms transmitted from the signal measurement device, performing pre-processing for side channel analysis of the collected waveforms, and performing side channel analysis using the pre-processed signals, and then generating and outputting side channel analysis result information.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a configuration diagram illustrating a general side channel analysis system;

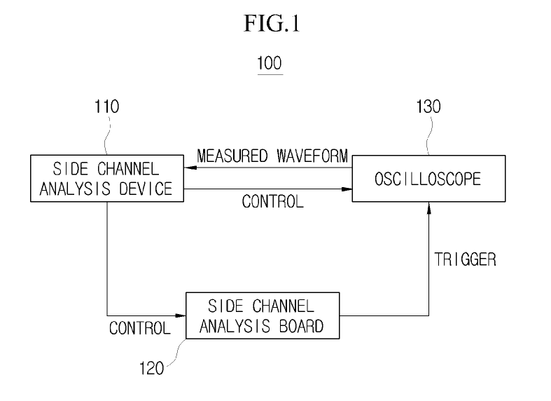

FIG. 2 is a diagram illustrating a block configuration of a side channel analysis system according to an embodiment of the present invention;

FIG. 3 is a diagram illustrating a detailed block configuration of a side channel analysis device shown in FIG. 2;

FIG. 4 is a diagram illustrating a detailed block configuration of a device to be analyzed shown in FIG. 2; and

FIG. 5 is an operational flowchart illustrating a side channel analysis method according to an embodiment of the present invention.

### DETAILED DESCRIPTION OF EXEMPLARY EMBODIMENTS

Example embodiments of the present invention are disclosed herein. Also, specific structural and functional details disclosed herein are merely representative for purposes of describing the example embodiments of the present invention. However, the example embodiments of the present invention may be embodied in many alternative forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The present invention provides a side channel analysis system and method in which a signal measurement device for collecting side channel analysis signals may input a trigger using light, and therefore side channel analysis may be performed on a device to be analyzed without a separate side channel analysis board.

Thus, in the side channel analysis system and method proposed in the present invention, a security module of a smartphone may be used to perform side channel analysis. However, the side channel analysis system and method of the present invention is not limited to the smartphone.

Hereinafter, a configuration and operation of a side channel analysis system according to an embodiment of the present invention will be described in detail with reference to the accompanying drawings.

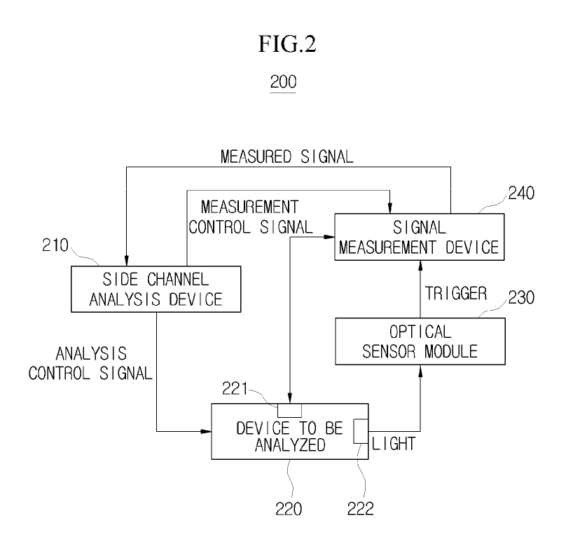

FIG. 2 is a configuration diagram illustrating a side channel analysis system according to an embodiment of the present invention.

Referring to FIG. 2, the side channel analysis system according to an embodiment of the present invention may include a side channel analysis device 210, a device 220 to be analyzed, an optical sensor module 230, and a signal measurement device 240, and the device 220 to be analyzed may include an encryption module 221 and a flash device 222.

Components shown in FIG. 2 are components required for describing the present invention, and it will be apparent to those of ordinary skill in the art that the side channel analysis system may have a larger number of components.

The side channel analysis device 210 controls overall operations of the side channel analysis system 200 in order to perform side channel analysis on the device to be analyzed. In this instance, the side channel analysis device 210 may transmit analysis control signals to the device 220 to be analyzed and the signal measurement device 240 to activate a function for side channel analysis.

Meanwhile, the side channel analysis device 210 transmits analysis control signals to the device 220 to be analyzed in order to perform side channel analysis, and then receives, from the signal measurement device 240, waveforms generated while the encryption module 221 of the device 220 to be analyzed is operated to thereby perform side channel analysis.

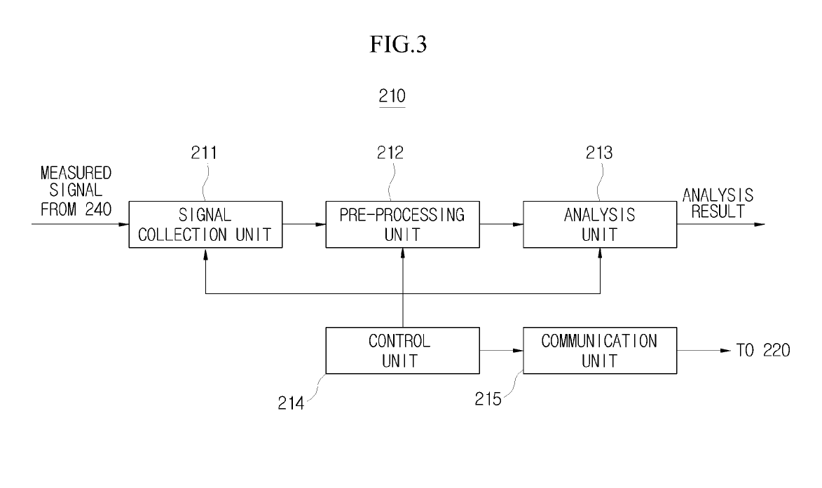

Meanwhile, a side channel analysis operation of the side channel analysis device 210 may be performed according to the various known methods, and thus will be described later with reference to FIG. 3. Here, the analysis control signals may be plaintext data for driving the encryption module 221 of the side channel analysis device 210.

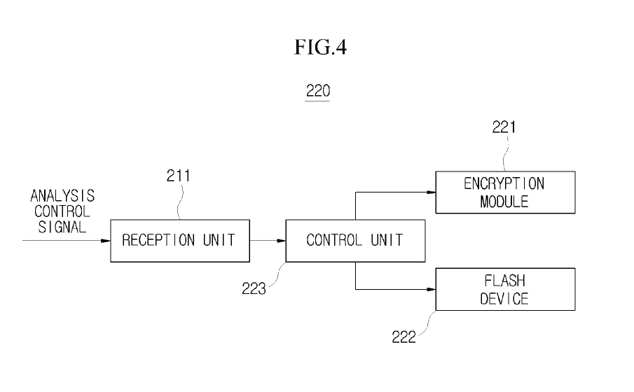

When receiving the analysis control signals from the side channel analysis device 210, the device 220 to be analyzed performs a predetermined operation so that side channel analysis may be performed according to the analysis control signals. In this instance, the device 220 to be analyzed performs an encryption function and a flash function according to the analysis control signals. The configuration and operation of the device 220 to be analyzed will be described in detail later with reference to FIG. 4.

In this instance, the device 220 to be analyzed may be connected to the side channel analysis device 210 in various methods. For example, the device 220 to be analyzed may be physically connected to the side channel analysis device 210 via a USB port to thereby transmit and receive signals, or via wireless communication such as Wi-Fi to thereby transmit and receive signals. Here, the device 220 to be analyzed may be a large number of mobile terminals including the flash function, for example, smartphones.

The optical sensor module 230 senses light output from the flash device 222 of the device 220 to be analyzed, generates a trigger corresponding to a signal value of the sensed light, and outputs the generated trigger to the signal measurement device 240.

In this instance, the optical sensor module 230 may generate a binary trigger according to whether light is made incident on the optical sensor module 230. Specifically, the optical sensor module 230 may output a logic “1” when light is made incident on the optical sensor module 230, and output a logic “0” when light is not made incident on the optical sensor module 230.

Conversely, the optical sensor module 230 may output the logic “1” when light is not made incident on the optical sensor module 230, and output the logic “0” when light is made incident on the optical sensor module 230.

Meanwhile, as long as the optical sensor module 230 may accurately sense light output from the flash device 222, the installation position of the optical sensor module 230 is not limited.

As an example, the optical sensor module 230 may be installed in the device 220 to be analyzed so as to be adjacent to an optical output terminal of the device 220 to be analyzed from which light is output, or installed in the signal measurement device 240 so as to be adjacent to a reception terminal of the signal measurement device 240 which receives the trigger.

The signal measurement device 240 receives the trigger transmitted from the optical sensor module 230, measures signals generated while the encryption module 221 of the device 220 to be analyzed is operated according to the received trigger, and transmits the measured signals to the side channel analysis device 210. Here, the measured signals may be waveforms of electric power, electromagnetic waves, and the like which are generated while the encryption module 221 of the device 220 to be analyzed is operated.

The signal measurement device 240 may be variously set according to measurement control signals transmitted from the side channel analysis device 210.

For example, when the logic “0” is input as the trigger, the signal measurement device 240 may be set to measure signals generated while the encryption module 221 is operated, according to the measurement control signals.

Conversely, when the logic “1” is input as the trigger, the signal measurement device 240 may be set to measure signals generated while the encryption module 221 is operated, according to the measurement control signals.

Meanwhile, the signal measurement device 240 may be an oscilloscope, but is not limited thereto, and any device may be applied and used as the signal measurement device 240 as long as it can measure the signals generated while the encryption module is operated.

Hereinafter, the configurations and operations of the side channel analysis device 210 and the device 220 on which side channel analysis is to be performed will be described in detail with reference to FIGS. 3 and 4.

FIG. 3 is a diagram illustrating an internal block configuration of the side channel analysis device 210 shown in FIG. 2, and FIG. 4 is a diagram illustrating an internal block configuration of a device to be analyzed shown in FIG. 2.

Referring to FIG. 3, the side channel analysis device 210 may include a signal collection unit 211, a pre-processing unit 212, an analysis unit 213, a control unit 214, and a communication unit 215.

The signal collection unit 211 may be configured to collect the measured signals transmitted from the signal measurement device 240, and transmit and receive the signals to and from the signal measurement device 240 according to a wired/wireless communication method. Communication between the signal collection unit 211 and the signal measurement device 240 may be performed in the various known communication methods, and detailed description thereof will be omitted.

The pre-processing unit 212 performs pre-processing so as to facilitate to perform side channel analysis on the measured signals collected through the signal collection unit 211, and the specific structure and operation of the pre-processing unit 212 have been already known, and thus detailed configuration and operation thereof will be omitted.

The analysis unit 213 performs side channel analysis on the measured signals pre-processed by the pre-processing unit 212, and then generates and outputs a side channel analysis result. Here, the specific operation of the analysis unit 213 has been already known, and thus detailed description thereof will be omitted.

The control unit 214 may control overall operations of the side channel analysis device 210, and control overall operations of the side channel analysis system 200.

In this instance, the control unit 214 may set plaintext data and the like for controlling operation parameters according to mutual input among the device 220 to be analyzed, the optical sensor module 230, and the signal measurement device 240 and the operation of the encryption module 221 of the device 220 to be analyzed.

The communication unit 215 may be configured for connection with the device 220 to be analyzed, and may be a USB port physically connected to the device 220 to be analyzed or a wireless communication modem.

The device 220 to be analyzed shown in FIG. 4 may include the encryption module 221, the flash device 222, a control unit 223, and a reception unit 224.

The device 220 to be analyzed operates the encryption module 221 and the flash device 222 according to the analysis control signals transmitted from the side channel analysis device 210.

In this instance, when receiving the analysis control signals through the reception unit 224, the control unit 223 controls operations of the encryption module 221 and the flash device 222 according to the received analysis control signals.

The encryption module 221 performs an encryption function according to control of the control unit 223, and the flash device 222 performs a flash function. In this instance, the encryption module 221 and the flash device 222 are operated while having a correlation. Here, the flash function may refer to an on/off output function of optical signals.

As an example, the control unit 223 may control the device 220 to be analyzed so that the encryption module 221 may be operated while the flash device 222 is turned on to output light, and then the flash device 222 may be turned off.

Conversely, the control unit 223 may control the device 220 to be analyzed so that the encryption module 221 may be operated in a state in which the flash device 222 is turned off and the flash device 222 may be turned on when the operation of the encryption module 221 is completed.

In this instance, signals generated while the encryption module 221 is operated may be measured by the signal measurement device 240 to be used to perform side channel analysis, and whether light is output from the flash device 222 may be used as the trigger of the signal measurement device 240. Here, the signals generated while the encryption module 221 is operated may be signals such as electric power, electromagnetic waves, or the like.

Meanwhile, the device 220 to be analyzed may be a smartphone, but it not limited thereto. Various types of electronic apparatuses including the encryption module and the flash device may be used as the device 220 on which side channel analysis is to be performed.

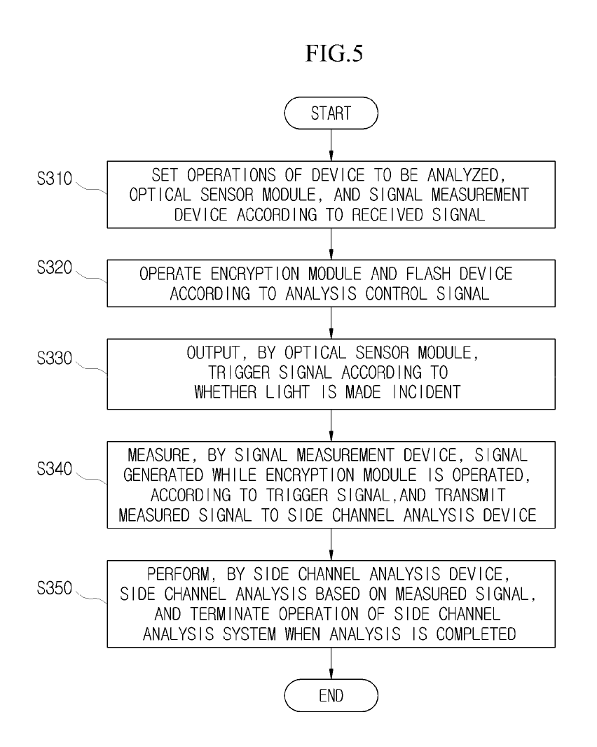

Hereinafter, a side channel analysis method according to an embodiment of the present invention corresponding to the operations of the side channel analysis system according to the above-described embodiment of the present invention will be described with reference to FIG. 5 in a stepwise manner.

FIG. 5 is an operational flowchart illustrating a side channel analysis method according to an embodiment of the present invention.

First, in operation S310, the side channel analysis method sets various parameters for measuring signals used for side channel analysis. In this instance, as the set various parameters, the side channel analysis method may set logical values output from the optical sensor module 230 according to an on/off state of the flash device 222, whether the signal measurement device 240 is operated according to the output logic of the optical sensor module 230, plaintext data values for driving the encryption module 221 in the device 220 to be analyzed, and control parameter values for driving the flash device 222. That is, when the device 220 to be analyzed, the optical sensor module 230, and the signal measurement device 240 receive signals, the side channel analysis method may set control values concerning which operation is performed to correspond to the received signals, and setting for the operation of each device may be performed according to control of the side channel analysis device 210.

Next, the device 220 to be analyzed is operated according to side channel analysis control signals provided from the side channel analysis device 210 in operation S320. In this instance, the encryption module 221 performs the encryption function and the flash device 222 performs the flash function.

When the device 220 to be analyzed is operated, the encryption module 221 and the flash device 222 are operated according to the state set in operation S310. In this instance, the device 220 to be analyzed may be set in such a manner that the encryption module 221 performs the encryption operation in a state in which the flash device 222 is turned on so that light is output.

In addition, the device 220 to be analyzed may be set in such a manner that the encryption module 221 performs the encryption operation in a state in which the flash device 222 is turned off so that light is not output.

Next, in operation S330, the optical sensor module 230 determines whether light output from the flash device 222 is made incident on the optical sensor module 230, generates a trigger, and outputs the generated trigger to the signal measurement device 240.

In this instance, the optical sensor module 230 may generate a binary trigger according to whether light is made incident on the optical sensor module 230, output a logic “1” when light is made incident, and output a logic “0” when light is not made incident.

Conversely, the optical sensor module 230 may output the logic “1” when light is not made incident, and output the logic “0” when light is made incident.

Next, in operation S340, the signal measurement device 240 receives the trigger transmitted from the optical sensor module 230, measures signals generated while the encryption module 221 of the device 220 to be analyzed is operated according to the received trigger, and transmits the measured signals to the side channel analysis device 210. In this instance, when the logic “0” is input as the trigger, the signal measurement device 240 may be set to measure the signals generated while the encryption module 221 is operated.

Conversely, when the logic “1” is input as the trigger, the signal measurement device 240 may be set to measure the signals generated while the encryption module 221 is operated.

Next, in operation S350, the side channel analysis device 210 performs side channel analysis based on the measured signals transmitted from the signal measurement device 240, and terminates the operation of the side channel analysis system when side channel analysis is completed.

As described above, according to the embodiments of the present invention, the signal measurement device for collecting side channel analysis signals may input the trigger using light, and therefore side channel analysis may be performed on the device to be analyzed without a separate side channel analysis board.

Thus, by applying the side channel analysis system and method according to the present invention to smart devices such as a smartphone in which side channel analysis is difficult to be performed due to the absence of a separate analysis board, side channel analysis may be performed.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A side channel analysis system comprising:
a side channel analysis device for outputting control signals for side channel analysis and performs side channel analysis based on received measurement signals;
a device to be analyzed for performing generation and encryption function of optical signals for side channel measurement, according to the control signals provided from the side channel analysis device;
an optical sensor module for detecting the optical signals generated from the device to be analyzed, and generates and outputs trigger signals according to the detected optical signals; and
a signal measurement device for measuring waveforms of at least one signal generated according to an encryption operation of the device to be analyzed using the trigger signals output from the optical sensor module, and provides the measured waveforms to the side channel analysis device.

2. The side channel analysis system of claim 1, wherein the device to be analyzed includes
an encryption module for performing the encryption function according to the control signals provided from the side channel analysis device, and
a flash device for controlling generation of the optical signals by turning on/off a flash function according to the control signals provided from the side channel analysis device.

3. The side channel analysis system of claim 2, wherein the encryption module performs the encryption function after outputting light by turning on the flash function of the flash device, or performs the encryption function in a state of turning off the flash function.

4. The side channel analysis system of claim 1, wherein the side channel analysis device and the device to be analyzed are connected with each other via at least one of a USB and a Wi-Fi interface.

5. A side channel analysis system comprising:
a signal measurement device for measuring signals for side channel analysis of a device on which side channel analysis is to be performed; and
a side channel analysis device performing side channel analysis using the signals measured by the signal measurement device,
wherein the device on which side channel analysis is to be performed includes
an encryption module for performing an encryption function according to analysis control data provided from the side channel analysis device,
an optical generation module generating optical signals according to the analysis control data provided from the side channel analysis device, and
an optical sensor module for detecting the optical signals generated from the optical generation module, and provides the detected optical signals as trigger signals for signal measurement in the signal measurement device.

6. A side channel analysis method comprising:
performing, by a device to be analyzed, an encryption function and a flash function according to side channel analysis control signals provided from a side channel analysis device;
detecting, by an optical sensor module, optical signals generated according to the flash function from the device to be analyzed, and outputting the detected optical signals as trigger signals;
measuring, by the device to be analyzed, signals generated while performing the encryption function according to the trigger signals output from the optical sensor module, and providing the measured signals from a signal measurement device to the side channel analysis device; and
performing, by the side channel analysis device, side channel analysis by receiving the measured signals provided from the signal measurement device.

7. The side channel analysis method of claim 6, further comprising:
setting, by the side channel analysis device, an operation parameter for performing generation and encryption function of optical signals in the device to be analyzed, and providing side channel analysis control signals according to the set operation parameter to the device to be analyzed via a communication interface.

8. The side channel analysis method of claim 6, wherein a communication interface for transmitting side channel analysis control signals to the device to be analyzed uses at least one of a USB and a Wi-Fi interface.

9. The side channel analysis method of claim 6, wherein the performing of the encryption function and the flash function includes performing, by an encryption module, an encryption operation in a state in which a flash device is turned on so that light is output, or performing, by the encryption module, the encryption operation in a state in which the flash device is turned off so that light is not output.

10. The side channel analysis method of claim 6, wherein the performing of the side channel analysis by the side channel analysis device includes
collecting measured waveforms transmitted from the signal measurement device,
performing pre-processing for side channel analysis of the collected waveforms, and
performing side channel analysis using the pre-processed signals, and then generating and outputting side channel analysis result information.
